(19) United States
(12) Patent Application Publication
(10) Pub. No.: US 2013/0124093 A1
(43) Pub. Date: May 16, 2013

(54) Communication Port For Use On A Wellbore Measuring Instrument

(71) Applicants: Jonathan Yeboah, Sugar Land, TX (US); Sebastine Ujereh, JR., Houston, TX (US); Laurent Villegas, Houston, TX (US); Christopher S. (Chris) Del Campo, Houston, TX (US)

(72) Inventors: Jonathan Yeboah, Sugar Land, TX (US); Sebastine Ujereh, JR., Houston, TX (US); Laurent Villegas, Houston, TX (US); Christopher S. (Chris) Del Campo, Houston, TX (US)

(73) Assignee: Schlumberger Technology Corporation, Sugar Land, TX (US)

(21) Appl. No.: 13/505,053

(22) PCT Filed: Jun. 3, 2010
(86) PCT No.: PCT/US10/37224

§ 371 Date: Nov. 20, 2012

Related U.S. Application Data
(60) Provisional application No. 61/258,656, filed on Nov. 6, 2009.

(51) Int. Cl. G06F 17/00; G01V 13/00; G01V 9/00

(52) U.S. Cl. CPC G06F 17/00; G01V 9/00; G01V 13/00
USPC 702/6; 29/874; 29/858

(57) ABSTRACT

A wellbore measurement instrument includes a housing configured to move along an interior of a wellbore. At least one sensor is configured to measure a wellbore parameter. A controller is disposed in the housing. The controller includes at least one of a data storage device and a device to control operation of the at least one sensor. A communications port is disposed in an aperture in the housing. The port includes an industry standard connector matable with an industry standard terminated cable for connection to a surface device when the instrument is at the Earth's surface.

### CROSS-REFERENCE TO RELATED APPLICATIONS

Priority is claimed from U.S. Provisional Application No. 61/258,656 filed on Nov. 6, 2009.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of instruments moved through wellbores drilled through subsurface rock formations, wherein such instruments measure one or more parameters related to the wellbore, the conveyance mechanism and/or the rock formations. More specifically, the invention relates to communication connectors associated with such instruments to enable communication of data stored in the instrument and/or communication of control or operating instructions to such instruments when the instrument is at the Earth's surface.

2. Background Art

Many types of wellbore measurement instruments are known in the art. Such instruments generally include an elongated, pressure resistant housing configured to move through a wellbore drilled through subsurface rock formations. The housing generally includes one or more sensors that measure selected parameters in the wellbore. The parameters, without limitation, include those related to the physical properties of the wellbore itself (e.g., temperature, pressure, fluid content, wellbore geodetic trajectory); construction of the wellbore (e.g., torque and/or axial force applied to a drill bit) and the formations surrounding the wellbore (e.g., resistivity, acoustic velocity, neutron interactive properties, density, and pore fluid pressure and composition).

The housing may be configured to be moved through the wellbore using several different techniques known in the art, including, without limitation, within a drill string or other jointed pipe string, on coiled tubing, or on armored electrical cable or slickline.

Irrespective of the conveyance device used, and irrespective of the types of sensor(s) used in any particular wellbore measurement instrument, such instruments typically include some form of data storage device therein and/or a controller that may be reprogrammed so that measurement and/or data storage and communication functions of the instrument may be changed to suit a particular purpose. Access to the data storage and/or access to the instrument controller typically requires electrical connection to a suitable communications port in the instrument, particularly for those instruments designed to be conveyed other than on an armored electrical cable. Communication ports known in the art include electrical connectors that are designed specifically for the particular instrument. More specifically, the arrangement of electrical contacts in the particular connector is typically unique to the type of instrument. Such arrangement of electrical contacts also requires that an electrical cable used to connect the communication port to a surface device (such as a computer or other data processor) must also be specially made to engage the electrical contacts on the communication port connector. Such specialized communication port connectors and corresponding cables can be expensive to manufacture, and may create logistical difficulties in the event of cable failure, e.g., timely obtaining a replacement.

### SUMMARY OF THE INVENTION

A wellbore measurement instrument according to one aspect of the invention includes a housing configured to move along an interior of a wellbore. At least one sensor is configured to measure a wellbore parameter. A controller is disposed in the housing. The controller includes at least one of a data storage device and a device to control operation of the at least one sensor. A communications port is disposed in an aperture in the housing. The port includes an industry standard connector matable with an industry standard terminated cable for connection to a surface device when the instrument is at the Earth's surface.

A method for making a communication connector for a wellbore measuring instrument according to another aspect of the invention includes selecting an industry standard connector base. The industry standard connector base is molded into a casing. The casing is made from a moisture-impermeable, electrically insulating material. Contact pins on the connector base are connected to selected circuits in the instrument. The casing is inserted into a port in a wall of a housing of the instrument. The inserting is performed to at least prevent entry of moisture into an interior of the housing.

Other aspects and advantages of the invention will be apparent from the following description and the appended claims.

### BRIEF DESCRIPTION OF THE DRAWINGS

FIG. 1 shows an example MWD/LWD wellbore meaurement instrument system operating in a wellbore.

FIGS. 1A, 1B and 1C show various views of a prior art proprietary design communication connector.

FIG. 2 shows the prior art proprietary design electrical feedthrough communication connector of FIG. 1 disposed in a tool port.

FIG. 3 shows a prior art cable and power supply used with the connector and communication port of FIGS. 1A, 1B, 1C and 2 to connect the communications port to a surface device.

FIGS. 4A, 4B and 4C show different views of an example feedthrough communications connector according to the invention.

FIG. 5 shows the example feedthrough communications connector of FIGS. 4A, 4B and 4C assembled to the tool port, similar to the view in FIG. 2.

FIGS. 6A through 6F show various examples of industry standard universal serial bus (USB) connector configurations.

FIGS. 7A and 7B show examples of “firewire” (IEEE 1394) connector configurations.

FIGS. 8A through 8E show examples of industry standard plug connectors that terminate a communications cable and may be used to connect a surface device to one of the example connectors shown in FIGS. 4A, 4B, 4C.

### DETAILED DESCRIPTION

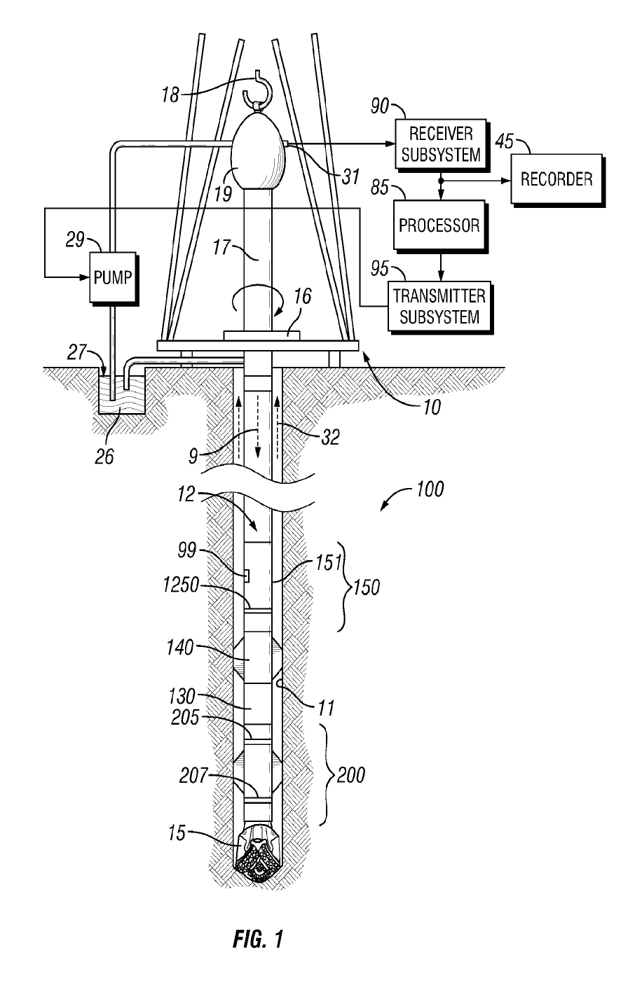

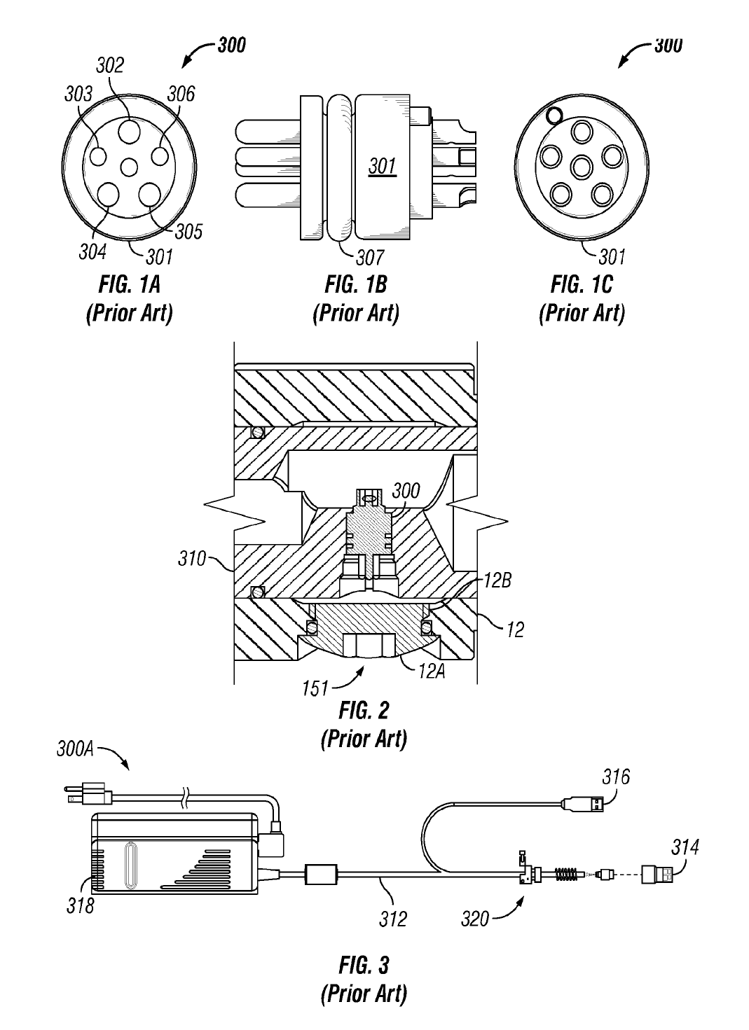

Referring to FIG. 1, there is illustrated an example wellbore measurement instrument that can be used with the invention. The instrument in the present example is in the form of a measuring-while-drilling apparatus. As used herein, “wellbore measurement instrument” is intended to mean any instrument configured to move along the interior of a wellbore and make measurements of at least one parameter related to the wellbore, the formations surrounding the wellbore or the dynamics of a conveyance device used to move the instrument along the wellbore.

The example manner of instrument conveyance shown in FIG. 1 is known as measurement-while-drilling, also called measuring-while-drilling or logging-while-drilling and is intended to include the taking of measurements in a wellbore near the end of a jointed pipe assembly. Such pipe assembly typically includes a drill bit and at least some of the drill string (the jointed pipe assembly) in the wellbore during drilling, pausing, and/or tripping. It is to be clearly understood that the example shown in FIG. 1 is intended only to serve as an example of wellbore measurement instruments and modes of instrument conveyance that may be used in accordance with the invention. Other modes of instrument conveyance include, without limitation, by any other form of segmented (jointed) pipe, coiled tubing, wireline, slickline, hydraulic pumping and wellbore tractors. Accordingly, the invention is not limited to use with while drilling instrumentation as shown in FIG. 1.

In the example of FIG. 1, a platform and derrick 10 are positioned over a borehole 11 that is formed in the subsurface rock formations by rotary drilling. A drill string 12 is suspended within the borehole and includes a drill bit 15 at its lower end. The drill string 12 and the drill bit 15 attached thereto are rotated by a rotating table 16 (energized by means not shown) which engages a kelly 17 at the upper end of the drill string. The drill string 12 is suspended from a hook 18 attached to a travelling block (not shown). The kelly 17 is connected to the hook through a rotary swivel 19 which permits rotation of the drill string 12 relative to the hook. Alternatively, the drill string 12 and drill bit 15 may be rotated from the surface by a “top drive” (not shown) type of drilling rig. Drilling fluid or mud 26 is contained in a tank or pit 27. A pump 29 pumps the drilling fluid into the drill string 12 via a port in the swivel 19 to flow downward (arrow 9) through the center of drill string 12. The drilling fluid exits the drill string 12 via courses or nozzles (not shown) in the drill bit 15 and then circulates upward in the annular space between the outside of the drill string 12 and the wall of the wellbore, commonly referred to as the “annulus”, as indicated by the flow arrows 32. The drilling fluid lubricates and cools the bit 15 and carries formation cuttings to the surface. The drilling fluid is returned to the pit 27 for recirculation. An optional directional drilling assembly (not shown) with a mud motor having a bent housing or an offset sub could also be used. It is also known in the art to use a “straight housing” mud driven motor to turn the bit either alone or in combination with rotational energy supplied from the surface (kelly 17 or top drive [not shown]).

Mounted within the drill string 12, preferably near the drill bit 15, is a bottom hole assembly, generally referred to by reference numeral 100, which includes capabilities for measuring, processing, and storing information, and communicating with a recording unit 45 at the earth's surface. As used herein, “near” the drill bit 15 generally means within several drill collar lengths from the drill bit. The bottom hole assembly 100 includes a measuring and local communications apparatus 200 which is described further below. The local communications apparatus may accept as input signals from one or more sensors 205, 207 which may measure any “wellbore parameter” as described above.

In the example of the illustrated bottom hole assembly 100, a drill collar 130 and a stabilizer collar 140 are shown successively above the local communications apparatus 200. The collar 130 may be, for example, a “pony” (shorter than the standard 30 foot length) collar or a collar housing for a measuring apparatus which performs measurement functions. The need for or desirability of a stabilizer collar such as 140 will depend on drilling parameters.

Located above stabilizer collar 140 is a surface/local communications subassembly 150. The communications subassembly 150 in the present example may include a toroidal antenna 1250 used for local communication with the local communications apparatus 200, and a known type of acoustic communication system that communicates with a similar system at the earth's surface via signals carried in the drilling fluid or mud.

The to-surface communication system in subassembly 150 includes an acoustic transmitter which generates an acoustic signal in the drilling fluid that is typically representative of one or more measured downhole parameters. One suitable type of acoustic transmitter employs a device known as a “mud siren” which includes a slotted stator and a slotted rotor that rotates and repeatedly interrupts the flow of drilling fluid to establish a desired acoustic wave signal in the drilling fluid. Electronics (not shown separately) in the communications subassembly 150 may include a suitable modulator, such as a phase shift keying (PSK) modulator, which conventionally produces driving signals for application to the mud transmitter. These driving signals can be used to apply appropriate modulation to the mud siren. The generated acoustic mud wave travels upward in the fluid through the center of the drill string at the speed of sound in the fluid.

The acoustic wave is received at the surface of the earth by transducers represented by reference numeral 31. The transducers, which are, for example, piezoelectric transducers, convert the received acoustic signals to electronic signals. The output of the transducers 31 is coupled to the surface receiving subsystem 90 which is operative to demodulate the transmitted signals, which can then be coupled to processor 85 and the recording unit 45.

A surface transmitting subsystem 95 may also be provided, and can control interruption of the operation of pump 29 in a manner which is detectable by transducers (represented at 99) in the communication subassembly 150, so that there can be two way communication between the subassembly 150 and the surface equipment when the wellbore measurement instrument is disposed in the wellbore. In such systems, surface to wellbore communication may be provided, e.g., by cycling the pump(s) 29 on and off in a predetermined pattern, and sensing this condition downhole at the transducers 99.

The foregoing or other technique of surface-to-downhole communication can be utilized in conjunction with the features disclosed herein. The communication subsystem 150 may also conventionally include (not show separately for clarity of the illustration) acquisition, control and processor electronics comprising a microprocessor system (with associated memory, clock and timing circuitry, and interface circuitry) capable of storing data from one or more sensors, processing the data and storing the processed data (and/or unprocessed sensor data), and coupling any selected portion of the information it contains to the transmitter control and driving electronics for transmission to the surface. A battery (not shown) may provide electrical power for the communications subassembly 150. As is known in the art, a downhole generator (not shown) such as a so-called “mud turbine” powered by the drilling fluid, can also be used to provide power, for immediate use or battery recharging, during times when the drilling fluid is moving through the drill string 12. It will be understood that alternative acoustic or other techniques can be employed for communication with the surface of the earth. As will be explained in more detail below, communication with the microprocessor system in the communications subassembly 150 when the instrument is at the surface is an element of one embodiment. The communications subassembly 150 may have a communications port 151 in the wall of the part of the drill string 12 including the communications subassembly 150 for such purpose, to be explained in more detail below.

In other examples of a wellbore measurement instrument that are conveyed other than as part of a drill string (see the examples described above), the instrument housing may include a similar communications port through the wall thereof.

As explained above with reference to FIGS. 1A, 1B and 1C, electrical signal communication to the wellbore measurement instrument, when the instrument is removed from the wellbore and is disposed at the surface, is typically performed by connecting an electrical cable to a connector disposed inside the communications port (151 in FIG. 1). Electrical connections known in the art include a specially built connector, having a proprietary electrical contact arrangement. FIG. 1A shows an end view of a typical prior art electrical connector 300, which includes electrical contacts 302, 303, 304, 305, 306 arranged in a proprietary pattern and formed into a casing 301 made from impermeable, electrically insulating material. FIG. 1B shows the connector 300 in side view, wherein the casing 301 may include provision for an o-ring 307 or similar seal. The opposed end view (which is inside the housing when the connector is assembled to the instrument) of the connector 300 is shown in FIG. 1C. The connector 300 in FIGS. 1A, 1B and 1C is typically configured to withstand the maximum expected hydrostatic pressure of fluid in the wellbore to prevent leakage of wellbore fluid into the interior of the wellbore measurement instrument if the exterior of the connector 300 becomes exposed to the wellbore fluid. Such connectors are known as “feedthrough bulkhead” connectors.

FIG. 2 shows a cross section of the prior art connector 300 assembled to the wellbore measurement instrument. The communications port 151 is formed by creating a suitable aperture 12B in the wall of the appropriate part of the drill string 12 (e.g., one of the collar sections such as the one which houses the communication system 150 in FIG. 1). The connector 300 is disposed in a suitable opening in an internal instrument chassis 310. The drill string aperture 12B may be sealed by a suitable plug 12A.

FIG. 3 shows a typical communications cable system 300A that may be used with the prior art communication port and connector (300 in FIGS. 1A, 1B, 1C) explained above to provide signal communication between the wellbore measurement instrument and a surface device, which may acquire the data in storage in the instrument, or may communicate control signals to the instrument, such as a computer (not shown). The surface device may also be a computer (not shown separately) forming part of the recording unit (45 in FIG. 1). The cable system 300A may include a power supply 318 that converts conventional operating power (e.g., 120 volt 60 cycle or 220 volt 50 cycle AC) to +5 and −5 volts DC to operate the communications electronics in the communications subsystem (150 in FIG. 1). The converted power is conducted along power cable 312 to a cable adapter 320. The cable adapter 320 has two outlet cables, one shown at 316 which terminates in an industry standard termination, such as universal serial bus (USB), firewire (IEEE 1394), RS232, RJ11 (telephone jack), ISO/IEEE 802/3 (Ethernet) or any other industry standard connection compatible with a corresponding connector on the surface device (e.g., computer or recording unit). The other outlet cable is shown at 314 and includes a termination that corresponds to proprietary terminal arrangement of the connector shown at 300 in FIGS. 1A, 1B and 1C.

As used herein, the term “industry standard” is intended to mean any connector and/or cable that is made according to the specification of at least one electronics industry standards setting organization. One example of such an organization is the Institute of Electrical and Electronics Engineers (IEEE) which sets standards for the USB and IEEE 1394 connectors mentioned above. Another example of a standards setting organization is the Electronic Industries Alliance (EIA). Yet another example of a standards setting organization is the Deutsches Institut für Normung (DIN), which sets industry standards for such electronic connectors and other devices in Germany. The foregoing are only intended as examples of organizations that define specifications for standard electrical connectors and are not intended to limit the scope of the types of connectors that may be used with the invention.

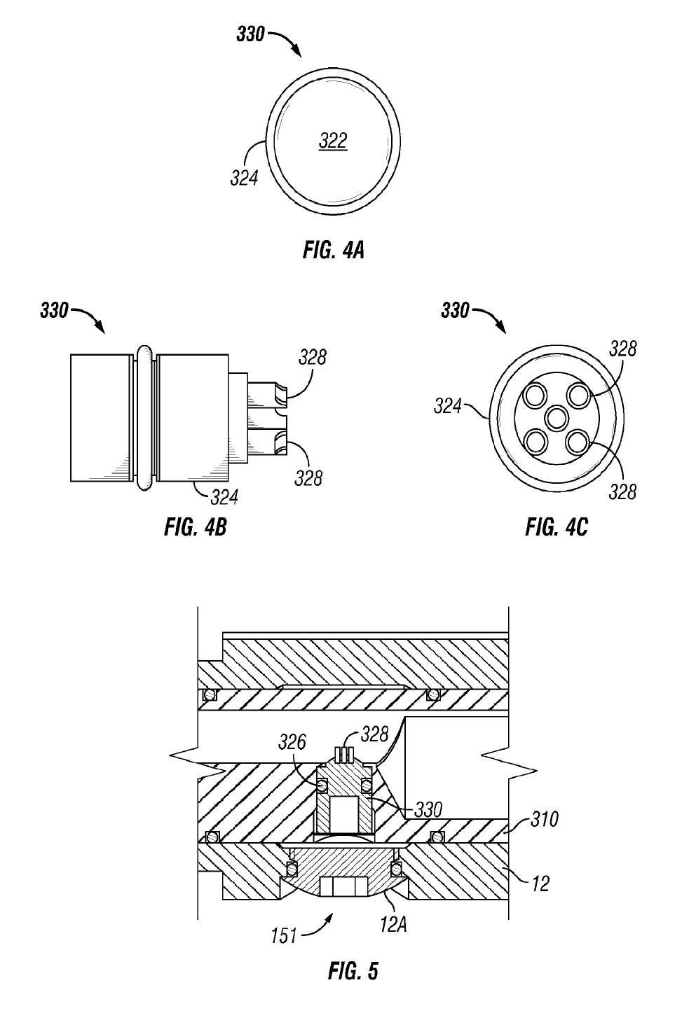

An example communication connector according to the invention is shown at 330 in FIGS. 4A, 4B and 4C. An end view in FIG. 4A shows an industry standard connector base 322 molded into a casing 324. The casing 324 may be made from any material that is essentially impermeable to moisture and is electrically non-conductive. Examples of suitable materials for the casing 324 include, without limitation, plastic, rubber, ceramic, glass and various curable resins. As shown in a side view in FIG. 4B, the casing 324 may include a suitable feature for an o-ring 326 or similar seal to sealingly engage the casing 324 with the port (FIG. 5). Contact pins 328 to make electrical connection to the circuits in the wellbore instrument (e.g., communication subsystem 150 in FIG. 1) are shown in FIG. 4B and in the opposed end view of FIG. 4C. Depending on the geometry of the connector base 322 and the geometry and composition of the casing 324, the connector 330 may also form a pressure barrier to prevent entry of wellbore fluid into the interior of the instrument in the event of seal failure of the plug (12A in FIG. 5A, explained below).

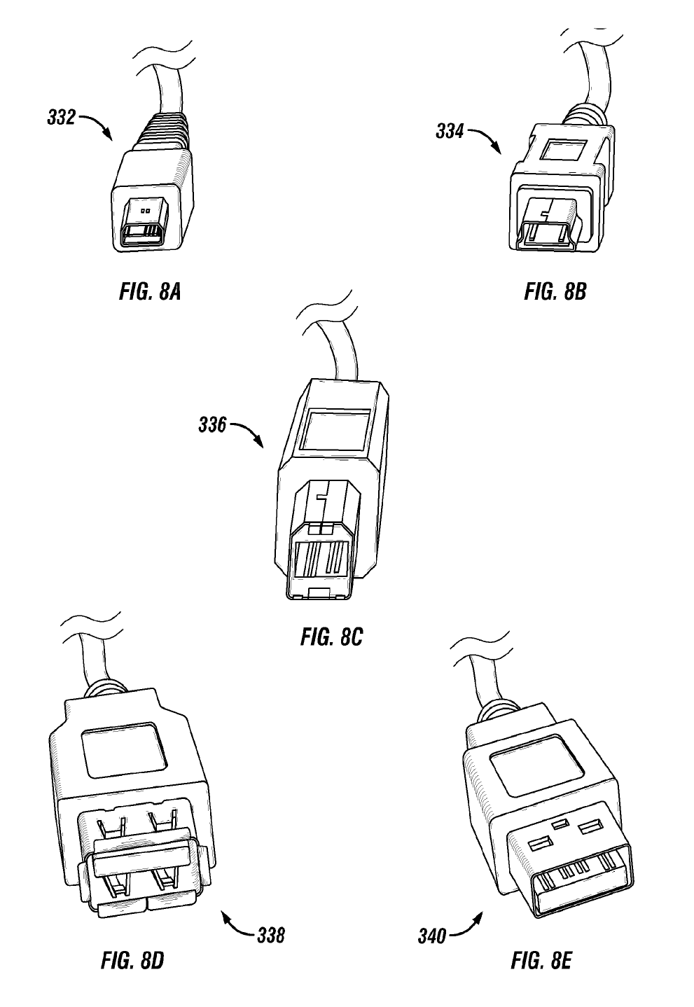

The industry standard connector base 322 in FIG. 4A is intended to mate with a corresponding industry standard electrical contact plug (e.g., see FIG. 8A-8E) on a communications cable (or the male and female terminations may be respectively reversed with respect to the connector 330 and the plug. The industry standard connector base 322 may be, without limitation, any of the foregoing examples listed above, including universal serial bus (USB), firewire (IEEE 1394), RS232, RJ11 (telephone jack), ISO/IEEE 802/3 (Ethernet) or any other industry standard connection matable with a corresponding electrical connector that terminates a connector cable (see FIGS. 8A-8E).

FIG. 5 shows the connector 330 assembled to the wellbore measurement instrument in the communications port 151. The port 151 may be sealingly closed using a plug 12A.

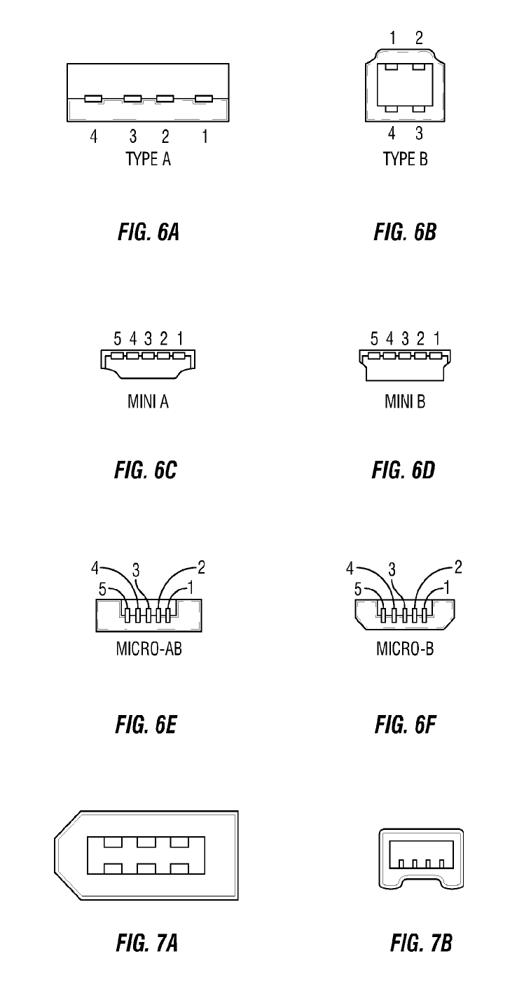

Some examples of IEEE USB connectors that may be used for the communications connector (330 in FIG. 4) are shown in FIGS. 6A through 6F. Some examples of IEEE 1394 connectors (“firewire”) that may be used for the communications connector are shown in FIGS. 7A and 7B.

To connect the surface device (e.g., computer or recording unit 45 in FIG. 1) to the communication connector (330 in FIG. 4) it is possible to use commercially available, “off the shelf” cables pre-terminated with a connector configured to mate to the selected “off the shelf” communications connector (330 in FIG. 4). Examples of such pre-terminated cables are shown in FIGS. 8A through 8E. At 332-340, respecctively. The examples shown in the foregoing figures are for IEEE USB connectors. It should be clearly understood that any other industry standard termination corresponding to the arrangement used in the communications connector (330 in FIG. 4) may be used with a communications cable according to the invention. The other end of the cable (e.g., as shown at 332-340 FIGS. 8A through 8E) should have a connector compatible with a receptacle or other connection on the surface device (e.g., computer or recording unit 45 in FIG. 1) used to access the data storage in the wellbore measurement instrument and/or to access the controller in the wellbore measurement instrument (e.g., the communications subsystem 150 in FIG. 1).

Communication connectors made according to various aspects of the present invention may provide lower manufacturing and maintenance costs for wellbore measurement instruments, and may reduce logistical problems associated with using proprietary configuration electrical cables to connect an instrument communication subsystem to a surface device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A wellbore measurement instrument, comprising:
a housing configured to move along an interior of a wellbore;
at least one sensor configured to measure a wellbore parameter;
a controller disposed in the housing, the controller including at least one of a data storage device and a device to control operation of the at least one sensor; and
a communications port disposed in an aperture in the housing, the port including an industry standard connector matable with an industry standard terminated cable for connection to a surface device when the instrument is at the Earth's surface.

2. The instrument of claim 1 wherein the industry standard connector comprises a universal serial bus connector.

3. The instrument of claim 1 wherein the industry standard connector comprises a firewire connector.

4. The instrument of claim 1 wherein the industry standard connector comprises an industry standard connector base formed into a casing, the casing made from a moisture-impermeable and electrically non-conductive material.

5. The instrument of claim 4 wherein the casing includes an external feature for a seal to engage the aperture.

6. The instrument of claim 4 wherein the casing is formed from at least one of plastic, rubber, ceramic, glass and curable resin.

7. The instrument of claim 1 further comprising a seal plug disposed over the communications port, the plug sealingly engaging the housing to exclude wellbore fluid from entering an interior of the housing.

8. A method for making a communication connector for a wellbore measuring instrument, comprising:
selecting an industry standard connector base;
molding the industry standard connector base into a casing, the casing made from a moisture impermeable, electrically insulating material;
electrically connecting contact pins on the connector base to selected circuits in the instrument; and
inserting the casing into a port in a wall of a housing of the instrument, the inserting performed to at least prevent entry of moisture into an interior of the housing.

9. The method of claim 8 further comprising connecting a communications cable terminated at one end with a connector matable with the industry standard connector base to contacts in the industry standard connector base, and connecting the other end of the communications cable to a surface device.

10. The method of claim 9 wherein the surface device comprises a computer.

11. The method of claim 10 wherein the other end of the cable is terminated with at least one of a universal serial bus connector and a firewire connector.
